(19) United States
(12) Patent Application Publication
(10) Pub. No.: US 2016/0306313 A1
(43) Pub. Date: Oct. 20, 2016

(54) IMAGE FORMING APPARATUS

(71) Applicant: KAZUOSA KUMA, KANAGAWA (JP)

(72) Inventor: KAZUOSA KUMA, KANAGAWA (JP)

(21) Appl. No.: 15/089,896

(22) Filed: Apr. 4, 2016

(30) Foreign Application Priority Data
Apr. 17, 2015 (JP) 2015-085373
Jan. 13, 2016 (JP) 2016-004442

(51) Int. Cl. G03G 15/00; B65H 5/22

(52) U.S. Cl. CPC G03G 15/6529; B65H 5/224; B65H 2515/70

(57) ABSTRACT

A sheet conveyance device includes an endless conveyance belt including an insulating material, formed into a loop, a suction device, and a plurality of rollers. The conveyance belt includes a plurality of holes. The suction device is disposed inside the loop of the conveyance belt, to generate a suction force to attract a recording medium onto a surface of the conveyance belt through the plurality of holes in the conveyance belt. Each of the plurality of rollers, which are stretching the conveyance belt, includes a conductive material and is electrically grounded.

### CROSS-REFERENCE TO RELATED APPLICATION

This patent application is based on and claims priority pursuant to 35 U.S.C. §119(a) to Japanese Patent Application Nos. 2015-085373, filed on Apr. 17, 2015, and 2016-004442, filed on Jan. 13, 2016, in the Japan Patent Office, the entire disclosure of each of which is hereby incorporated by reference herein.

### BACKGROUND

1. Technical Field

Aspects of the present disclosure relate to a sheet conveyance device and an image forming apparatus incorporating the sheet conveyance device.

2. Related Art

An image forming apparatus including a sheet conveyance device is known that includes an endless belt wound around a pair of rollers, to convey a sheet along the belt while attracting the sheet onto the belt.

Such a sheet conveyance device includes, for example, a drive roller, a driven roller, two rollers, an endless conveyance belt entrained about these four rollers, and a negative pressure generator disposed on the inner side in a radial direction of the conveyance belt.

The conveyance belt includes a sheet conveying face on the upper surface of the conveyance belt, to convey a sheet while attracting the sheet to the sheet conveying face. The conveyance belt further includes a plurality of air vents, each penetrating through the conveyance belt in a belt thickness direction. Each air vent exerts a negative pressure generated by the negative pressure generator on the sheet.

Such a negative pressure generator includes a fan and a fan case enclosing the fan. The fan case has a case body with the upper side open and has a thick top plate covering the upper side of the case body. The fan case includes the fan on the lower surface of the fan case, to be driven by a drive motor to generate negative pressure within the fan case.

### SUMMARY

In an aspect of this disclosure, there is provided an improved sheet conveyance device including an endless conveyance belt including an insulating material, formed into a loop, a suction device, and a plurality of rollers. The conveyance belt includes a plurality of holes. The suction device is disposed inside the loop of the conveyance belt, to generate a suction force to attract a recording medium onto a surface of the conveyance belt through the plurality of holes in the conveyance belt. Each of the plurality of rollers, which are stretching the conveyance belt, includes a conductive material and is electrically grounded. In another aspect of this disclosure, there is provided an improved image forming apparatus further including the sheet conveyance device, and an image forming device disposed upstream in a direction of conveyance of the conveyance belt to form an image on the recording medium.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view of an image forming apparatus including a sheet conveyance device according to a first embodiment of the present disclosure;

FIG. 2 is a schematic view of a sheet conveyance device according to the first embodiment of the present disclosure;

FIG. 3 is a perspective view of a conveyance belt according to the first embodiment of the present disclosure;

FIG. 4 is a cross-sectional view of a suction fan motor according to the first embodiment of the present disclosure;

FIG. 5 is a schematic view of a sheet conveyance device according to a second embodiment of the present disclosure; and

FIG. 6 is a schematic view of a sheet conveyance device according to a third embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in a similar manner, and achieve a similar result.

Although the embodiments are described with technical limitations with reference to the attached drawings, such description is not intended to limit the scope of the disclosure and all of the components or elements described in the embodiments of this disclosure are not necessarily indispensable. In the drawings for describing the following embodiments, the same reference codes are allocated to elements (members or components) having the same function or shape and redundant descriptions thereof are omitted below.

### First Embodiment

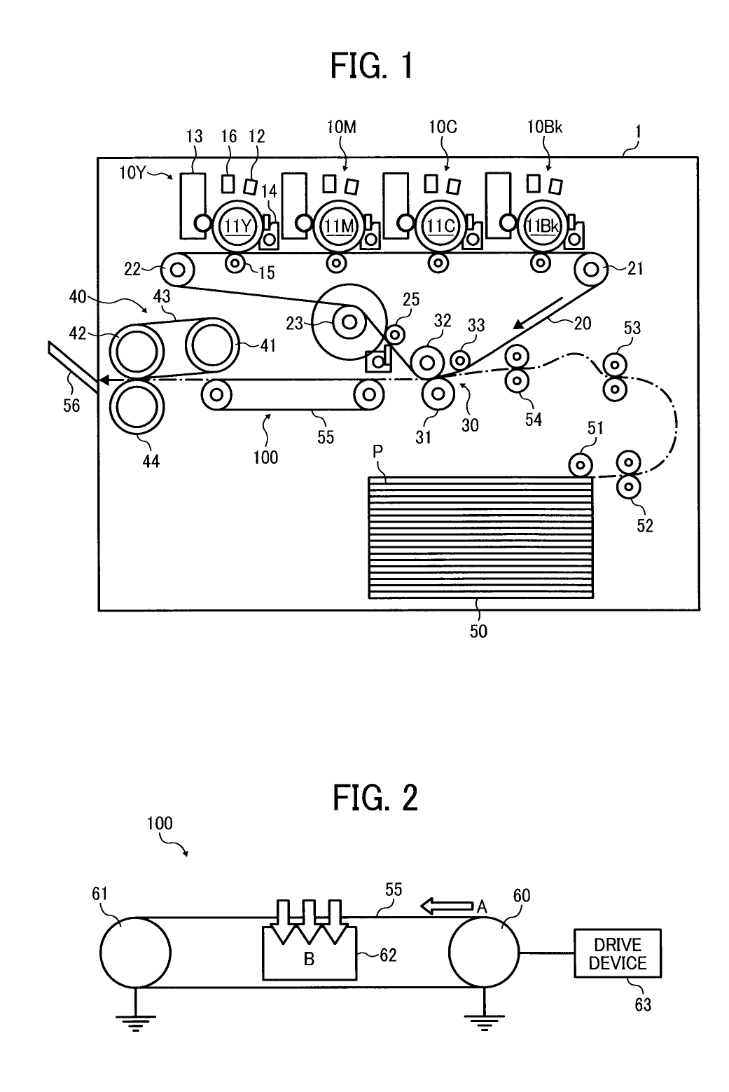

A description is provided of the schematic configuration of the image forming apparatus including the sheet conveyance device according to a first present embodiment with reference to FIG. 1. It is to be noted that in the embodiments to be described below, an image forming apparatus that employs an electrophotography method to form a full-color image is represented as an example. The present disclosure is not limited to this image forming apparatus, and is also applicable to a monochrome image forming apparatus for forming a monochrome image.

As illustrated in FIG. 1, an image forming apparatus 1 according to the present embodiment is a color image forming apparatus that adopts a tandem system, for forming a full-color image. The image forming apparatus 1 includes four-color separated image forming units 10Y, 10M, IOC, and 10Bk (yellow, magenta, cyan, and black in the recited order), a plurality of support rollers 21, 22, 23, 25, 32, and 33, and an endless looped intermediate transfer belt 20 wound around the rollers. The image forming units 10Y, 10M, 10C, and 10Bk are disposed along an upper belt course of the intermediate transfer belt 20. Hereinafter, the image forming units 10Y, 10M, 10C, and 10Bk are collectively referred to as image forming units 10 unless colors distinguished.

The image forming units 10Y, 10M, 10C, and 10Bk have the same configuration, except for different colors of toner employed. Taking the image forming unit for yellow 10Y in the leftmost of FIG. 1 as an example, elements that constitute the image forming unit 10Y are given with reference numerals. Other elements that constitute each of the other image forming units 10M, 10C, and 10Bk are omitted. The image forming unit 10Y includes the photoconductor drum 11 as an image bearer, a charging device 12, a developing device 13, a photoconductor cleaner 14, and a primary transfer roller 15. The charging device 12 is disposed around the photoconductor 11, and the primary transfer roller 15 is disposed opposing to the photoconductor, to constitute a primary transfer unit inside the loop of the intermediate transfer belt 20.

The image forming apparatus 1 includes an exposure device 16, such as a light emitting diode (LED), a laser diode (LD), or a xenon lamp, for each image forming unit 10, disposed between the charging device 12 and the developing device 13. As the exposure device 16, a laser writing device may be employed in common for all of the image forming units 10M, 10C, and 10Bk.

The image forming apparatus 1 further includes a secondary transfer roller 31 opposed to a secondary-transfer opposed roller 32, which is one of the support rollers of the intermediate transfer belt 20. On the right side of the secondary transfer roller 31 is disposed a conveyance roller pair 54 to convey a sheet P as a recording medium, and on the left side of the secondary transfer roller 31 is disposed a conveyance belt 55.

A fixing device 40 is disposed on the left side of the conveyance belt 55. The fixing device 40 as a belt fixing device includes a heat roller 41, a fixing roller 42, a fixing belt 43 wound around the heat roller 41 and the fixing roller 42, and a pressing roller 44 pressed against the fixing roller 42 with the fixing belt 43 interposed between the pressing roller 44 and the fixing roller 42.

At the bottom of the image forming apparatus 1 is disposed a sheet feeding tray 50 to store a bundle of sheets P, including a pick-up roller 51 and a separate sheet feeding roller 52 that constitute a sheet feeder.

In FIG. 1, a conveyance roller 53 is disposed at an appropriate position along a sheet conveyance path indicated by a broken line. Optionally, a sheet guide is disposed along the sheet conveyance path. In addition, a manual sheet feeder or a sheet reverse unit may be provided. In some embodiments, the image forming apparatus 1 further includes an image reading device, such as a scanner, or an automatic document feeder (ADF). It should be noted that the configuration of the respective elements of the image forming apparatus 1 is only an example, and the image forming unit 10Y, 10M, 10C, and 10Bk may be disposed in an arbitrary order in the tandem image forming apparatus.

A brief description is provided of an image forming operation of the image forming apparatus 1 according to the present embodiment, as described above. Hereinafter, photoconductors 11Y, 11M, 11C, and 11Bk are sometimes collectively referred to as the photoconductor 11.

The photoconductor 11 (11Y, 11M, 11C, and 11Bk) in the image forming unit 10 is rotated by a driver, such as a drive motor, in the counterclockwise direction, and the changing device 12 uniformly charges the surface of the photoconductor 11 to a predetermined polarity.

The charged surface of the photoconductor 11 is irradiated with scan light from the exposure device 16 to form an electrostatic latent image on the surface of the photoconductor 11. More specifically, the exposure device 16 directs the laser beams according to single color data, namely, yellow, cyan, magenta, and black color data decomposed from a desired full-color image data to the surfaces of the photoconductors 11Y, 11M, 11C, and 11Bk.

The electrostatic latent image formed on the photoconductor 11 is developed with toner of respective colors by the developing device 13 into a visible image, known as a toner image.

The intermediate transfer belt 20 is driven to move in the clockwise direction, and the primary transfer roller 15 primarily transfers the toner image on the respective photoconductors 11Y, 11, M, 11C, and 11Bk onto the intermediate transfer belt 20 in the image forming unit 10 such that they are superimposed one on another. Accordingly, the intermediate transfer belt 20 bears a full-color toner image on the surface thereof.

It should be noted that any one of the image forming unit 10Y, 10M, 10C, and 10Bk is employed to form a monochrome image, and two or more of the image forming units 10Y, 10M, 10C, and 10Bk are employed to form a multi-color image. In the case of a monochrome printing, among the four image forming units 10Y, 10M, 10C, and 10Bk, the image forming unit 10Bk for black in the rightmost side of FIG. 1 is used to form a monochrome image.

After a toner image is primarily transferred onto the intermediate transfer belt 20, residual toner remaining on the surface of the photoconductor 11 is removed by the photoconductor cleaner 14. The surface having been cleaned is then subjected to electric charge removing by a discharger. Accordingly, the surface of the photoconductor 11 is initialized in preparation for the subsequent imaging cycle.

Meanwhile, the sheet P fed from the sheet feeding tray 50 is forwarded by the conveyance roller pair 54 to a secondary-transfer unit 30, timed to coincide with the toner image on the intermediate transfer belt 20.

With actions of the secondary transfer roller 31, the toner image is secondarily transferred from the intermediate transfer belt 20 onto the sheet P at a time. The secondary transfer roller 31 presses against the secondary-transfer opposed roller 32.

The sheet P having the toner image transferred thereonto is delivered to the fixing device 40 by the conveyance belt 55, and heat and pressure are applied to the sheet P while the sheet P passes through the fixing device 40. Accordingly, the toner image is melted and fixed on the sheet P. Then, the sheet P having the toner image fixed thereon is discharged to an output tray 56. It should be noted that the image forming apparatus 1 according to the present embodiment preferably includes the image forming unit 10 as an image forming device to form an image on the sheet P, disposed upstream from the sheet conveyance device 100 including the conveyance belt 55 in a direction of conveyance.

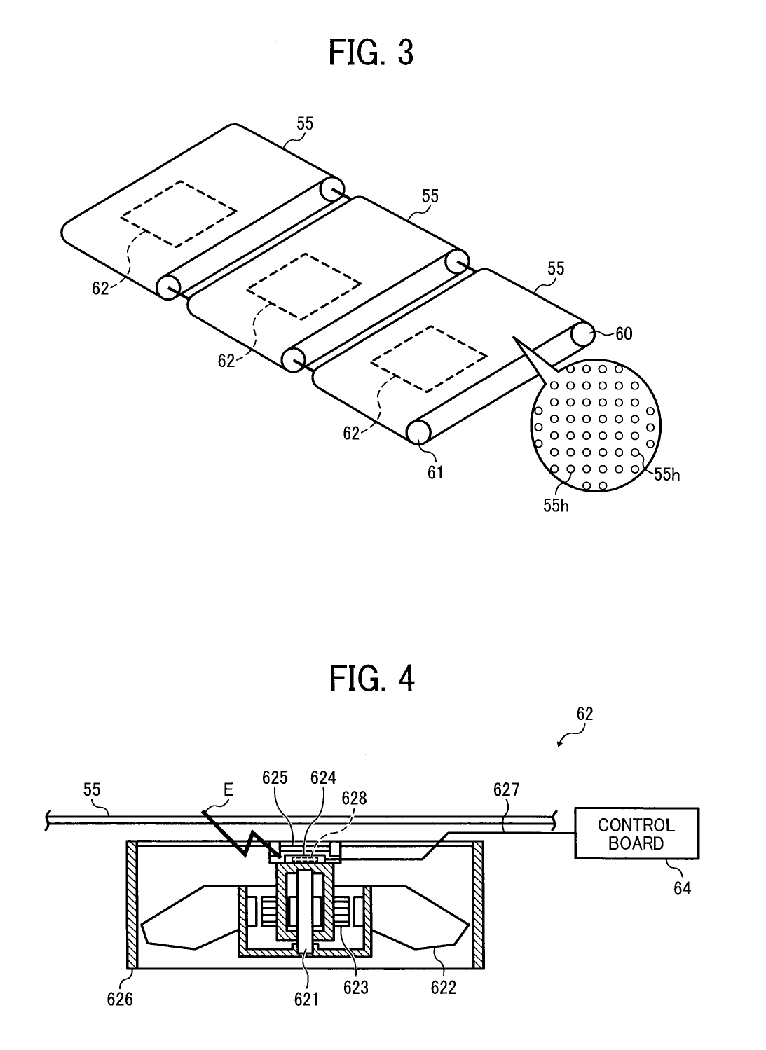

A further description is provided of a sheet conveyance device 100 according to a first embodiment of the present disclosure with reference to FIGS. 2 and 3.

As illustrated in FIGS. 2 and 3, a conveyance belt 55 of the sheet conveyance device 100 is made of an insulating material, such as a rubber, and includes a plurality of intake holes 55h (refer to an enlarged view of the holes 55h in FIG. 3) . The conveyance belt 55 is stretched taut around a drive roller 60 and a driven roller 61. In the right bottom of FIG. 3, the enlarged view of only a portion of the plurality of holes 55h is illustrated. The holes 55h are actually formed over the entire surface of the conveyance belt 55. It should be noted that the drive roller 60 and the driven roller 61 are sometimes referred to as rollers in the present embodiment. The sheet conveyance device 100 further includes a drive device 63 to apply a drive force to the drive roller 60 to move the conveyance belt 55 in a direction indicated by arrow A.

The conveyance belt 55 is made of an insulating rubber. That is, the entirety of the conveyance belt 55 is made of an insulating material. Alternatively, in some embodiments, the conveyance belt 55 is made of an insulating resin. With the entirety of the conveyance belt 55 made of insulating material, costs for the conveyance belt are reduced compared with the conveyance belt partially including conductive material.

Alternatively, in some embodiments, the conveyance belt 55 includes a base layer made of a conductive material and a surface layer made of an insulating material. In this case, the surface layer contacts the conductive rollers, i.e., the drive roller 60 and the driven roller 61 to more reliably prevent the conveyance belt 55 from being charged. With a portion of the conveyance belt 55 made of the insulating material, costs for the conveyance belt 55 is reduced compared with the conveyance belt with the entirety thereof made of a conductive material.

The conveyance belt 55 includes a suction fan motor 62, which is indicated by a broken line, as a suction device disposed in the inner side of the conveyance belt 55. A description of the suction fan motor 62 is provided with reference to FIG. 4. The suction fan motor 62 includes a shaft 621 of the suction fan motor 62, fines 622 fixed onto the shaft 621, coils 623, a driver integrated circuit (IC) 624, a seal 625, a housing 626, and a harness 627.

The driver IC 624 includes a control circuit 628, and the harness 627 in some embodiments is connected to a control board 64 as a controller of the main body of the image forming apparatus 1. The control circuit 628 of the driver IC 624 receives a control signal output from the control board 64, and controls the amount of current to be output to the coils 623 and the timing of outputting the current to the coils 623 accordingly.

In response to the current output to the coils 623, the shaft 621 and the fins 622 are driven to rotate at a predetermined timing and a predetermined speed. With the fins 622 driven to rotate, the suction force occurs to attract the sheet P borne on the conveyance belt 55 toward the surface of the conveyance belt 55.

Preferably, the distance between the upper surface of the housing 626 and the lower surface of the conveyance belt 55 ranges from 1 mm through 10 mm. In the present embodiment, the distance is designed to be 3 mm. The shaft 621, the fins 622 fixed onto the shaft 621, the coils 623, and the driver IC 624 are housed in the interior of the housing 626 made of an insulating resin. With the elements described above (621, 622, 623, and 624) housed in the insulating housing 626, static electricity E generated on the conveyance belt 55 is prevented from reaching the elements, particularly the driver IC 624.

With the configuration described above, the static electricity E generated by the triboelectric charging of the conveyance belt 55 is prevented from passing through a clearance between the elements and through a protection sheet of the elements to the driver IC 624, which prevents damage to the driver IC 624 accordingly. The above configuration further prevents the static electricity E from passing through the harness 627 to the control board 64, thus preventing damage to the control board 64.

The suction fan motor 62 generates a suction force in a direction indicated by arrow B to attract the sheet P, which is conveyed along the conveyance belt 55, toward the surface of the conveyance belt 55 via the holes 55h on the conveyance belt 55.

In the first embodiment, the drive roller 60 and the driven roller 61, which are made of conductive materials, are electrically grounded. Specifically, the surfaces of the drive roller 60 and the driven roller 61 are made of a metal material, and each surface of the rollers 60 and 61 is electrically grounded.

According to the first embodiment, even if friction occurs between the conveyance belt 55 and the rollers 60 and 61 due to rotation of the conveyance belt 55, thereby generating static electricity, the static electricity flows into the ground through the rollers 60 and 61, which are electrically grounded. As a result, the conveyance belt 55 is not charged. This configuration prevents static electricity from reaching the suction fan motor 62, thus preventing electric components in the interior of the suction fan motor 62 from being damaged due to the excessive amount of current.

### Second Embodiment

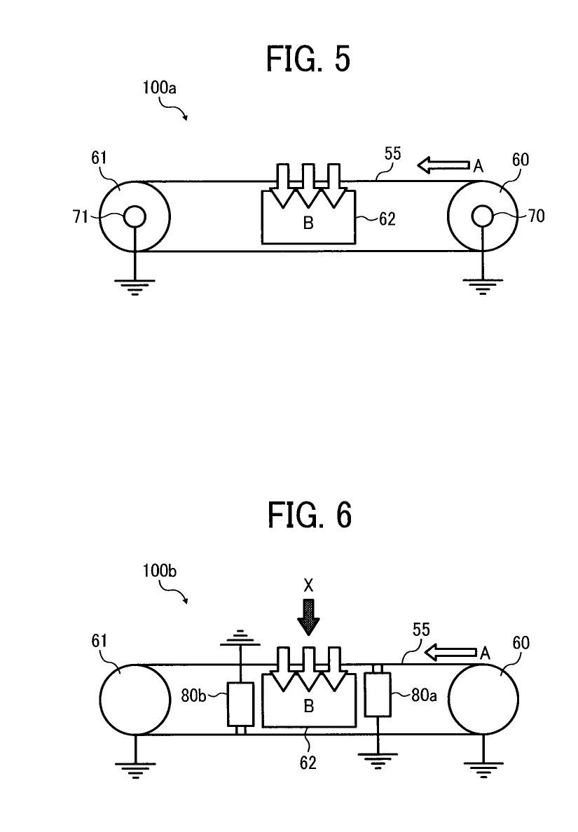

A description is provided of a sheet conveyance device 100a according to a second embodiment of the present disclosure with reference to FIG. 5. A description is omitted of the same aspects as those of the first embodiment.

The second embodiment differs from the first embodiment in that a drive roller 60 and a driven roller 61 of the sheet conveyance device 100a have surfaces made of a conductive resin material, and that a metal core 70 and a metal core 71 of the drive roller 60 and the driven roller 61, respectively, are electrically grounded. Examples of the conductive resin material preferably include a conductive rubber.

In the second embodiment, with the surfaces of the rollers 60 and 61 made of a conductive rubber, the metal cores 70 and 71 are electrically grounded to earth. This configuration increases a holding force of a conveyance belt 55 and rollers (the drive roller 60 and the driven roller 61), which prevents a sheet conveyance failure due to sliding of the rollers. In addition, even if friction occurs between the conveyance belt 55 and the rollers 60 and 61 due to the rotation of the conveyance belt 55, thereby generating static electricity, the static electricity flows into the ground through the rollers 60 and 61, which are electrically grounded. As a result, the conveyance belt 55 is not charged. This configuration prevents static electricity from reaching the suction fan motor 62, thus preventing electric components in the interior of the suction fan motor 62 from being damaged due to the excessive amount of current.

### Third Embodiment

A description is provided of a sheet conveyance device 100b according to a third embodiment of the present disclosure with reference to FIG. 6. A description is omitted of the same features as those of the first embodiment.

The third embodiment differs from the first embodiment in that a sheet conveyance device 100b of the third embodiment further includes electrically grounded conductive members contacting a conveyance belt 55, disposed upstream in the direction of conveyance of the conveyance belt 55. Specifically, the conductive members are disposed upstream from a position as a reference position indicated by arrow X, at which a suction fan motor 62 is opposed to the conveyance belt 55, in the direction of conveyance of the conveyance belt 55.

For example, a discharge brush or a non-woven fabric, which is electrically grounded, is preferably employed as the conductive member. In the third embodiment, the sheet conveyance device 100b includes discharge brushes 80a and 80b to discharge static electricity on the conveyance belt 55.

According to the third embodiment, the discharge brushes 80a and 80b discharge particularly around a suction fan motor 62 of the conveyance belt 55. This configuration prevents static electricity from reaching the suction fan motor 62, thus preventing electric components in the interior of the suction fan motor 62 from being damaged due to the excessive amount of current.

Further, in the image forming apparatus 1 including a sheet conveyance device according to any one of the embodiments described above, even when the speed of conveyance of a sheet slows down with contraction or expansion of a transfer roller caused by changes in the surrounding environment.

Although the description of the tandem image forming apparatus is provided as an example in each of the embodiments described above, the present disclosure is not limited thereto. The present disclosure is also applicable to an image forming apparatus including a plurality of developing devices around one photoconductor or a revolver image forming apparatus.

Alternatively, the present disclosure is applicable to a full-color device using three-color toner or to a multi-color device using two-color toner. Further, the present disclosure is also applicable to an ink-jet image forming apparatus. The image forming apparatus of the present disclosure is not limited to a printer. The image forming apparatus includes, but is not limited to, a copier, a printer, a facsimile machine, and a multi-functional system including a combination thereof.

The image forming apparatus according to the present embodiments employs a sheet conveyance device including a conveyance belt with holes to attract a sheet conveyed toward the surface of the conveyance belt, thus preventing a failure of a motor due to static electricity generated on the conveyance belt. Accordingly, the present disclosure is applicable to general-purpose image forming apparatuses, such as electrophotographic image forming apparatuses and ink-jet image forming apparatuses that convey a sheet along a conveyance belt, attracting the sheet toward the surface of the conveyance belt. Although two rollers 60 and 61 that support a belt are electrically grounded in the first embodiment through the third embodiment, the configuration of the two rollers 60 and 61 is not limited thereto. Instead, one of the rollers 60 and 61 is electrically grounded, and the other is electrically floating. In this case as well, the conveyance belt is prevented from being charged, thus preventing a failure of a drive device.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A sheet conveyance device, comprising:
an endless conveyance belt including an insulating material, formed into a loop, and including a plurality of holes;
a suction device disposed inside the loop of the conveyance belt, configured to generate a suction force to attract a recording medium onto a surface of the conveyance belt through the plurality of holes in the conveyance belt; and
a plurality of rollers stretching the conveyance belt, each of the plurality of rollers including a conductive material and being electrically grounded.

2. The sheet conveyance device according to claim 1, wherein each of the rollers has a surface made of a metal material and electrically grounded.

3. The sheet conveyance device according to claim 1, wherein each of the rollers has a surface made of a conductive resin material and a metal core electrically grounded.

4. The sheet conveyance device according to claim 1, further comprising an electrically grounded conductive member contacting the conveyance belt,
wherein the conductive member is disposed upstream from a position at which the conveyance belt is opposed to the suction device in a direction of conveyance of the conveyance belt.

5. An image forming apparatus comprising:
the sheet conveyance device according to claim 1; and
an image forming device disposed upstream in a direction of conveyance of the conveyance belt according to claim 1, to form an image on the recording medium.

6. The image forming apparatus according to claim 5, wherein the suction device includes an insulating housing, a fin, and a control circuit to control driving of the fin.
